(19) United States
(12) Patent Application Publication
(10) Pub. No.: US 2024/0265268 A1
(43) Pub. Date: Aug. 8, 2024

(54) FEDERATED LEARNING WITH SINGLE-ROUND CONVERGENCE

(71) Applicant: World Wide Technology Holding Co., LLC, Maryland Heights, MO (US)

(72) Inventors: Ina Poecher, Duluth, MN (US); Kevin Blaesing, Ann Arbor, MI (US); Remington Dechene, Laporte, CO (US); Kelly Burris, St. Charles, MO (US)

(73) Assignee: World Wide Technology Holding Co., LLC, Maryland Heights, MO (US)

(21) Appl. No.: 18/107,125

(22) Filed: Feb. 8, 2023

(51) Int. Cl. G06N 3/098; G06N 5/04

(52) U.S. Cl. CPC G06N 3/098; G06N 5/04

(57) ABSTRACT

A method including classifying a cluster training dataset by, for each datapoint of the cluster training dataset: obtaining a student prediction from each of a plurality of respective student machine-learning models for each a plurality of nodes of a cluster; performing a voting of the student predictions from the plurality of respective student machine-learning models of at least a portion of the plurality of nodes of the cluster to determine a respective classification for the datapoint; and labeling the datapoint of the cluster training dataset with the respective classification. The method also can include training a cluster machine-learning model of the cluster using the cluster training dataset, as classified. Other embodiments are described.

### TECHNICAL FIELD

This disclosure relates generally to federated learning with single-round convergence.

### BACKGROUND

Machine learning traditionally allows a computer or machine to learn from data in order to make future predictions. In the case of local machine learning, everything is done on an individual node level, with no communication of learned information between nodes. The local node's model is aware of only the local information it was fed and will use only this information to learn and make future predictions. If there are multiple local machine learning models learning across the same features and one model encounters different data than the others, only that one model will learn from that data. The other models that have not encountered such data will not learn from that data, which can result in an incorrect future prediction.

Distributed learning bridges the gap from single node machine learning and multi-node machine learning, which can improve performance, accuracy and allow for larger training datasets. In distributed learning, nodes train in parallel of each other but then communicate the results of their trainings to a central process for aggregation.

Traditional federated learning builds on this idea of distributed learning. It is a distributed machine learning approach in which multiple nodes collaboratively train a model, while keeping the raw data local to the nodes and instead communicating only model weights. The multi-nodal structure allows for faster processing of large data sets and improves accuracy. Federated learning takes advantage of distributed computing to lessen the load on a single node, but differentiates itself from general distributed learning by providing for privacy. Whereas distributed learning allows both the communication of model weights and raw data, federated learning restricts this communication of potentially private data, as well as adds noise to make reverse engineering the model increasingly difficult. The communicated model weights are then aggregated within in the central server using a federation aggregation algorithm to create one global model to be redistributed to the nodes within its network for future predictions. Federated learning thus allows for analyzing and learning from data distributed across many nodes, without exposing that data to other nodes. However, federated learning generally involves multiple rounds of training a central model and several rounds of communicating the weights back and forth.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for federated learning, according to an embodiment;

FIG. 4 illustrates a block diagram of the system of FIG. 3 in a tiered arrangement;

FIG. 5 illustrates a flow chart for a method of training students within a node, according to an embodiment;

FIG. 6 illustrates an example of majority voting for a student that has five teachers that receive a datapoint;

FIG. 7 illustrates a flow chart for a method of aggregating student models from the nodes of the cluster to train a cluster model, according to an embodiment;

FIG. 8 illustrates an example of consistency voting for the students models of a node;

FIG. 9 illustrates a flow chart for a method of aggregating cluster models from the cluster hubs to train a global model, according to an embodiment;

FIG. 10 illustrates an example of weighted majority voting at a global hub across six cluster models; and

FIG. 11 illustrates a flow chart for a method 1100 of performing federated learning, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than 1 millisecond (ms), 10 ms, 50 ms, 100 ms, 500 ms, or 1 second (s).

### DESCRIPTION OF EXAMPLES OF EMBODIMENTS

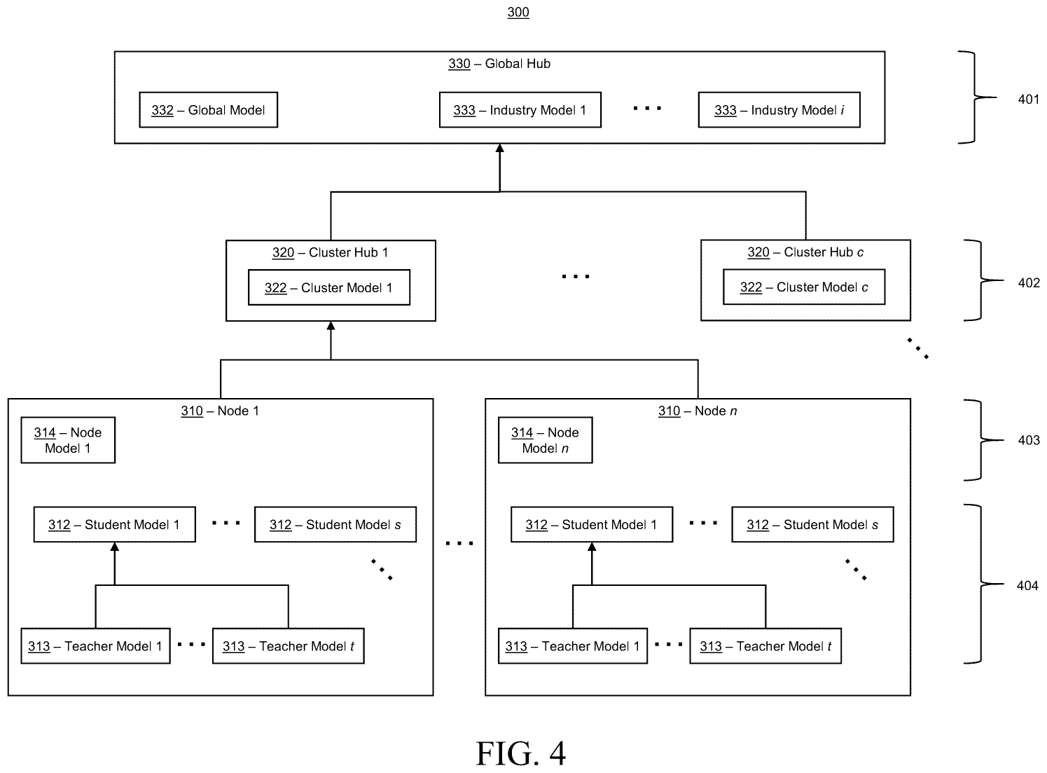

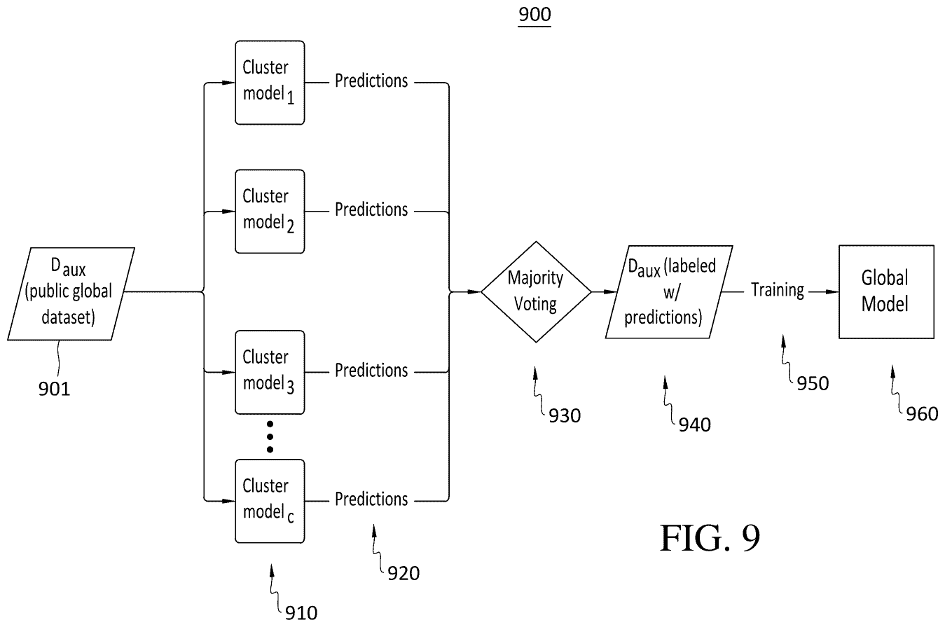

In a number of embodiments, the systems and methods described herein can provide for federated learning with single round convergence. In several embodiments, multiple tiers of federation can be used, such as a network of federated models, each comprised of their own network of federated models, that that are collectively aggregated using knowledge transfer to create a cross-silo federated machine learning network. This network can feed into one global model and/or multiple industry-specific models each tailored to their specific industry sectors, such as discussed below in connection with FIGS. 4 and 9. These industry-specific models can be trained using knowledge transfer in conjunction with weighted voting, while being round optimal and preserving differential privacy at each level. The term “industry,” in many embodiments, can refer to a characteristic of attribute that applies across multiple nodes, such as nodes that perform machine learning processing for a particular sector, discipline, geographic boundary, grouping, domain, hierarchical grouping, etc.

Employing federated machine learning across silos allows for creating industry-specific models that leverage knowledge transfer between nodes (indirectly through a hub) within the federated network. The aggregation algorithm used in such federated learning can utilize majority voting and/or consistency voting to aggregate machine learning models. The machine learning models can be based on concepts such as unsupervised learning, supervised learning, and reinforcement learning, and can be of various types, such as XGBoost, random forests, neural networks, graph neural networks (GNN), generative adversarial networks (GAN), temporal fusion transformer (TFT) models, autoencoder-type models, reinforcement learning (RL) models, hierarchical RL (HRL) models, etc.

Based on the method of aggregation, convergence time and types of models that can be handled by the federated system also become relevant factors. Using knowledge transfer in conjunction with something like weighted voting, the federated system can aggregate nodes in a system into a singular global model while simultaneously aggregating over multiple tiers to create industry-specific models tuned to the intricacies seen in a given industry. Using federated machine learning can provide the benefits of distributed machine learning, privacy preservation, and greater data consumption.

Federated machine learning can be used to solve a variety of use cases across industries. Embodiments of the techniques described herein provide an improvement over conventional federated learning by creating a federated network of federated networks to learn across data in order to create different tiers of “global” models and/or creating industry-specific models. In some cases, such data can be homogeneous, but in other cases, the techniques can be applied to heterogeneous data. For example, a data cleaning function can be used to calculate the values to be used in the federated learning based various fields in heterogeneous data.

Another advantage of embodiments of techniques described herein is utilizing federated machine learning in various applications, such as computer networking, computer network routing, geographic information systems (GIS), cellular networks, flight/driving paths, satellite communications, medical imaging, etc. For example, employing federated learning in a cross-silo method to computer networking allows different computer networks that do not interact to benefit from the learnings of other computer networks within the federated system. Data governance standards typically prohibit the direct sharing of data between computer networks with different policies (e.g., finance network vs. guest Wi-Fi). Federated machine learning can significantly improve privacy and allow for this communication of findings to be done without compromising sensitive data.

Various embodiments also provide for using federated learning for the computer network use case of intrusion detection and prevention systems (IDS/IPS), which is an improvement over conventional IDS/IPS systems. Current IDS/IPS that use machine learning to classify incoming traffic as good or bad typically do so on a localized level. For example, hundreds of nodes may each run the same model locally, with no voting or feedback, just an occasional (or regular) update across all the nodes. Using a federated approach allows for knowledge learned on one node within a computer network to be communicated to other nodes within the same computer network, without communicating the attacks seen by that node. In addition, implementing the cross-silo approach not only allows the learnings from computer network attacks seen on a node to be shared with the other nodes of the computer network, but such learning also can be shared across nodes within other computer networks, such as computer networks that have never seen that type of attack. Similarly, the cross-silo approach can share learnings that are not attack-related, such as unintentional human errors that may be nonetheless harmful.

Various embodiments also provide for using federating learning for security imagery use cases involving threat screenings. Current security camera systems use machine learning to identify areas of interest, such as movement, human faces, and anomalies in still or moving camera feeds in an attempt to identify an event. The contents of the imagery, and any resultant classification, could be considered at least sensitive and potentially legally protected from release to third parties without consent. Even if consent is available, imagery is quite large and can involve excessive costs to store, transmit, and process outside its node of origination. Using a cross-siloed federated approach, learnings from local security camera imagery systems can be shared amongst other security camera imagery systems, buildings, geographically distributed regions, and/or government agencies without compromising confidentiality, violating regulation, or incurring excess transmission costs and delays. This approach for shared learnings can advantageously protect the integrity of represented camera images while increasing the effectiveness of security camera imagery screenings across participants.

Various embodiments also provide for using federating learning for natural language processing use cases, such as spam detection. Currently, email providers use filters or simple artificial intelligence (AI) algorithms to try and identify spam emails. The data used to train these models typically comes from the platform specific to that email provider, without benefitting from collaboration between providers. Natural Language Processing (NLP) is a commonly used model for the application of spam detection, taking in words or phrases as input to classify the probability that an email is spam related. Creating a federation of federations to train an NLP model on a distributed set of nodes allows for higher detection rate of spam while preserving privacy. The nodes in this type of use case can include cell phones, applications, or laptops, as examples. Using the federated approach allows for access to a greater training set, and the learnings are shared across platforms to lessen the burden on users and at the same time preserving their privacy.

Various embodiments also provide for using federating learning for anomaly detection use cases that go beyond the attack detection focus of an IDS. Current anomaly detection systems learn typical expected behavior of an environment from historic monitoring of that environment or similar system to establish a baseline, and utilize algorithmic approaches such as heuristics to identify deviations from the baseline of that expected behavior to identify anomalies. Anomaly detection on distrusted systems are typically date-focused on activities within similar entities, such as computers of similar types running similar applications, such that baselines can be comparative. Typical distributed anomaly detection models can be shared amongst disparate entities, but are today merely localized in so much as they are updated to establish a localized baseline and localized anomalies. Localized learnings in these disparate systems are not directly transportable to disparate entities, such as to different types of computers with different application requirements in different industries. Using a cross-siloed federated approach, learnings of baselines and anomalous behavior can occur at various embodied disparate levels, including a system, organizational, and industry. This approach can allow for anomaly detection training and inference to be tailored at various levels of abstraction, preventing, for example, anomaly detection mechanisms from being over-fit to a locale or under-fit to a cluster.

Using federated learning across different silos can result in multi-tiered models, such as node models, cluster models, and a global model. Node models can be trained on local data that nodes encounter. Such data can stay private to the node. By training locally and communicating its resulting weights between a node and its associated cluster hub, without communicating local data, privacy can be preserved while still reaping the benefit of getting access to the knowledge obtained by other nodes within their cluster. In addition, by adding noise to the predictions on the training set, using a method such as LaPlace, makes it increasingly difficult to reverse engineer the models' weights to gain insight into the raw data. Once trained, the cluster models can be redistributed to the nodes, which can then use that cluster-level model to continue making predictions until a global update is pushed out or the nodes are told to retrain in order to update the cluster model.

The aggregation of model weights that goes on between clusters and the global level allows for nodes within different clusters to gain knowledge about what information nodes are encountering in different clusters. In addition, if it is important to a node to be tuned to specific data within their industry sector, then that node can be given an industry-specific model that results from using weighted voting between clusters and the global level. These industry-specific models can then be deployed to their associated nodes instead of the global model to allow such nodes to make predictions that are more tuned for their given environment, without sacrificing global knowledge. Doing so preserves the privacy of the data encountered by each node while also still communicating that knowledge to the other nodes within the federated system and highlighting on what certain nodes will predict more often within a certain industry sector.

Various embodiments include a method. The method can include classifying a cluster training dataset by, for each datapoint of the cluster training dataset: obtaining a student prediction from each of a plurality of respective student machine-learning models for each a plurality of nodes of a cluster; performing a voting of the student predictions from the plurality of respective student machine-learning models of at least a portion of the plurality of nodes of the cluster to determine a respective classification for the datapoint; and labeling the datapoint of the cluster training dataset with the respective classification. The method also can include training a cluster machine-learning model of the cluster using the cluster training dataset, as classified.

A number of embodiments include a system including one or more processors and one or more non-transitory computer-readable media storing computing instructions that, when executed on the one or more processors, cause the one or more processors to perform certain acts. The acts can include classifying a cluster training dataset by, for each datapoint of the cluster training dataset: obtaining a student prediction from each of a plurality of respective student machine-learning models for each a plurality of nodes of a cluster; performing a voting of the student predictions from the plurality of respective student machine-learning models of at least a portion of the plurality of nodes of the cluster to determine a respective classification for the datapoint; and labeling the datapoint of the cluster training dataset with the respective classification. The acts also can include training a cluster machine-learning model of the cluster using the cluster training dataset, as classified.

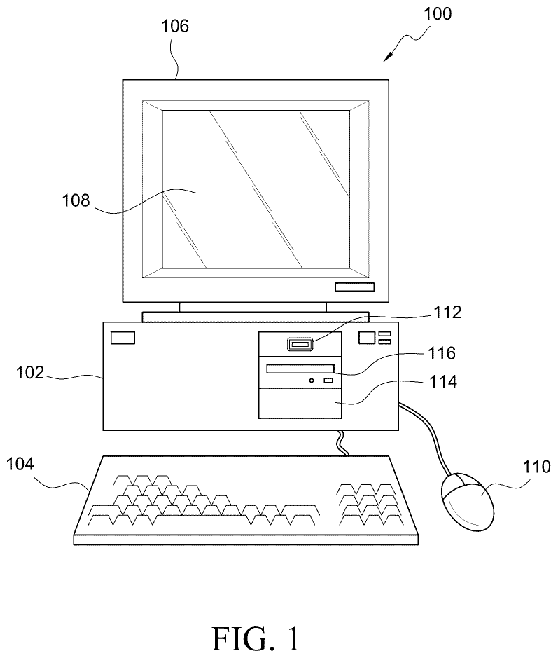

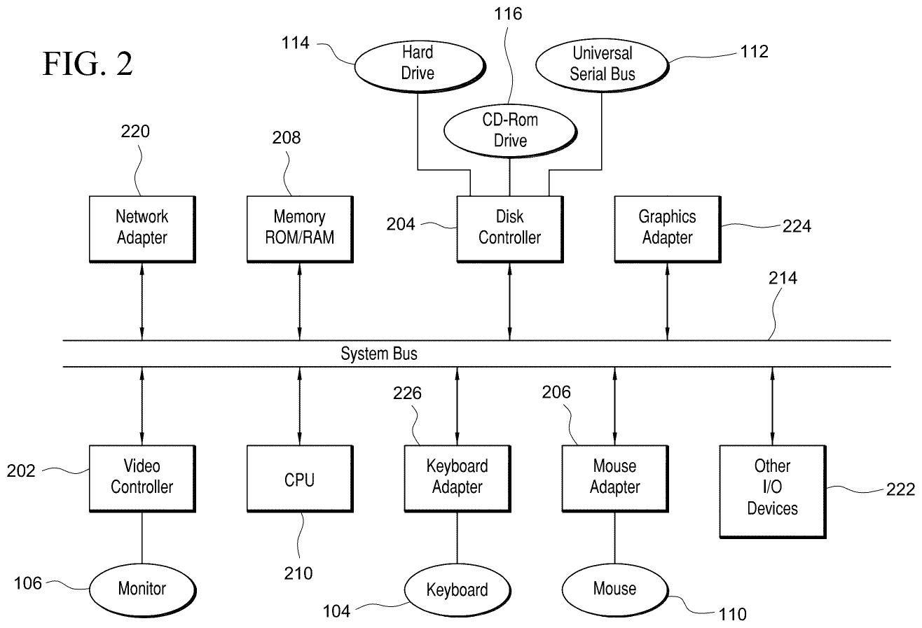

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICS.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

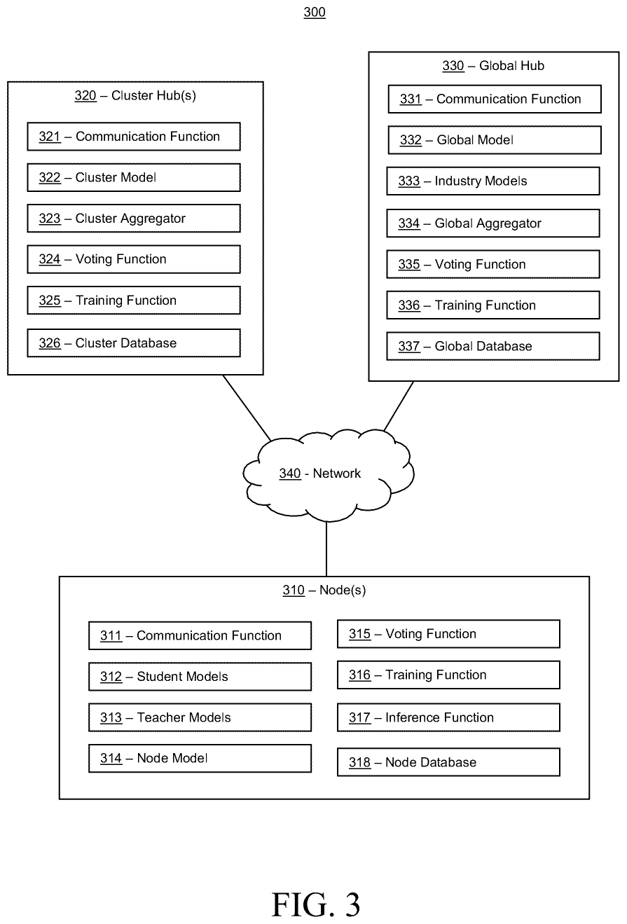

Turning ahead in the drawings, FIG. 3 illustrates a block diagram of a system 300 that can be employed for federated learning, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include nodes 310, one or more cluster hubs 320, and/or a global hub 330. In some embodiments, each of nodes 310, cluster hubs 320, and global hub 330 can each be a computer system, such as computer system 100 (FIG. 1), as described above, and can each be a single computer, a single server, or a cluster or collection of computers or servers, or a cloud of computers or servers. In some embodiments, a plurality of nodes 310 (and in some cases, a plurality of one or more cluster hubs 320 and/or a global hub 330) can be hosted on a single computer, or single server, such as multiple virtual machines, containers, processes, services, or other endpoints running on a single machine. Generally, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, nodes 310, cluster hubs 320, and global hub 330 can be in data communication with each other through a network 340. Network 340 can be the Internet or another suitable network. In many embodiments, nodes 310, cluster hubs 320, and/or global hub 330 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to nodes 310, cluster hubs 320, and/or global hub 330 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of nodes 310, cluster hubs 320, and global hub 330. In a similar manner, the processors and/or the non-transitory computer-readable media can be local and/or remote to each other.

Meanwhile, in many embodiments, nodes 310, cluster hubs 320, and global hub 330 also can be configured to include and/or communicate with one or more databases, such as a databases 318, 326, and 337. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, nodes 310, cluster hubs 320, and global hub 330, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In some embodiments, each of nodes 310 can include a communication function 311, student models 312, teacher models 313, node model 314, one or more voting functions 315, a training function 316, an inference function 317, and/or node database 318. In some embodiments, each of cluster hubs 320 can include a communication function 321, a cluster model 322, a cluster aggregator 323, one or more voting functions 324, a training function 325, and/or cluster database 326. In some embodiments, global hub 330 can include a communication function 331, a global model 332, one or more industry models 333, a global aggregator 334, one or more voting functions 335, a training function 336, and/or global database 337. These elements of nodes 310, cluster hubs 320, and global hub 330 are merely exemplary, and the same or other embodiments can include additional or different elements. In many embodiments, the functions of nodes 310, cluster hubs 320, and global hub 330 can be modules of computing instructions (e.g., software modules) stored at non-transitory computer readable media that operate on one or more processors. In other embodiments, the functions of nodes 310, cluster hubs 320, and global hub 330 can be implemented in hardware. In several embodiments, the communication functions 311, 321, and 331 of nodes 310, cluster hubs 320, and global hub 330, respectively, can involve input and/or output operations, which can be performed through any suitable communication method. In some embodiments, the communications provided by communication functions 311, 321, and 331 can be through publish-subscribe messaging. Additional details regarding the elements of nodes 310, cluster hubs 320, and global hub 330 are described further herein.

In many embodiments, each of nodes 310 can be a local processing location, which can, for example, be a place at which network traffic enters a network, or a place that receives network traffic. For example, a node 310 can be a device, a server, a desktop, a NIC (network interface controller (e.g., network adapter 220 (FIG. 2)), a SmartNIC (smart network interface controller), a router, a switch, a firewall, a load balancer, another suitable network device, an operating system, an application, an Internet of Things (IoT) device, a processing container (e.g., a container running on a network device), a virtual machine (VM), a virtual device context (VDC), etc., a virtual one of any of the foregoing elements that are a physical device (e.g., a virtual router), or a component thereof. In many embodiments, each of the nodes 310 each can be part of a cluster, which can be a grouping of nodes. In some examples, the grouping of nodes into a cluster can be based on nodes in a network, such that the nodes in a network are in a cluster, and the nodes in a different network are in a different cluster. Each cluster of nodes can have an associated cluster hub 320. The cluster hub 320 can be the location in which a cluster-specific aggregator 323 resides and where cluster database 326 that houses the trained cluster-defined model 322 resides. The cluster hubs collectively can be part of a global collection of clusters, which can be associated with global hub 330. The global hub 330 can be the location in which global aggregator 334 resides and where global database 337 that houses the trained global-defined model 332 resides.

Turning ahead in the drawings, FIG. 4 illustrates a block diagram of a system 300 in a tiered arrangement, including tiers 401-404. Tier 401 is the global tier, which includes global hub 330. The global hub 330 can generate and store a global model 332, and in some embodiments can generate and store one or more industry models 333, such as industry models 1 to i, where i represents the number of industry models. Tier 401 is where the clusters in tier 402 are aggregated to create global model 332 and/or industry models 333. At this level of aggregation, the clusters can go through voting (e.g., majority voting) and/or confidence filtering to label the dataset on which global model 332 is then trained. Global model 332 is a federation of federations, as global model is built off the knowledge of the federated models in tier 402 feeding into it. Global model 332 can be an all-knowing model. If an industry model is being trained, confidence filtering can occur, but the functionality of voting can be is slightly altered. Instead of all participants having an equal vote, those cluster models 322 that belong to the given industry can have a greater weighted vote than those that do not belong to the given industry. This process can result in an industry-defined model that is more sensitive to the type of data most seen within its relevant clusters while still gaining insights from the clusters not specific to the industry. Global model 332 and industry models 333 can be stored in global database 337 (FIG. 3)

Tier 402 is the cluster tier, which includes multiple cluster hubs 320, such as cluster hubs 1 to c, where c represents the number of clusters. As described above, each cluster can include a group of nodes 310. Tier 402 is where the layer at which cluster models 322 reside. Each cluster hub 320 can generate and store a respective cluster model 322. Collectively, tier 402 can include cluster models 1 to c. Cluster hub 320 is where the aggregation of the node-specific student models 312 takes place. In many embodiments, node-specific student models 312 can go through voting, such as consistency voting and/or majority voting, and, in some embodiments, a confidence filter can be applied, in creating the cluster model 322. Cluster model 322 can represent the combination of the knowledge of all nodes 310 within one cluster (e.g., nodes within a network). Cluster model 322 can be stored in cluster database 326 (FIG. 3), which can be a location to which the nodes have access in order to make future inferences.

Tier 403 is the node tier, which is the layer where nodes 310 reside. Under each cluster, there can be 1 to n, where n represents the number of nodes in that particular cluster. In tier 403, each node 310 can store a respective node model 314. Collectively, tier 402 can include node models 1 to n within each cluster. Node model 314 at node 310 can be obtained from the cluster hub 320 associated with the cluster that contains the node, and/or from global hub 330. Node model 314 can be used by node 310 to make inferences once the model has been trained. Node model 314 can be stored in node database 318 (FIG. 3).

Tier 404 is the student-teacher tier, which is created within each node of each cluster. A node 310 includes multiple student models 312, such as student models 1 to s, where s represents the number of student models 312 for node 310. For example, there can be 5 student models (also referred to as students), or another suitable number of students for each node 310. Each student model 312 can use multiple teacher models 313, such as teacher models 1 to t, where t represents the number of teacher models 313 for a student model 312. For example, there can be 3 teacher models (also referred to as teachers), or another suitable number of teacher models for each student model. Student models 312 and teacher models 313 reside within the node 310 and can be used for training the cluster model 322, such as when consistency voting is satisfied.

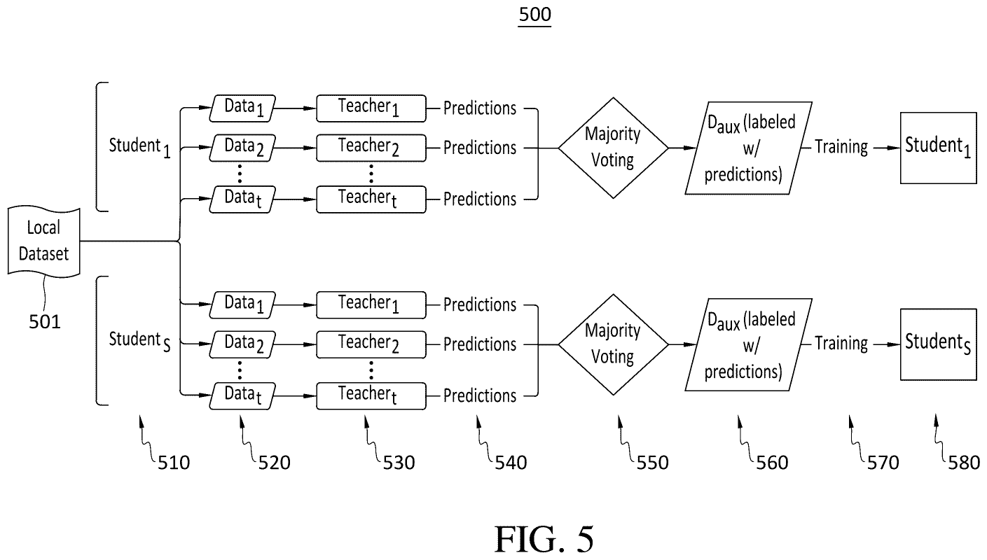

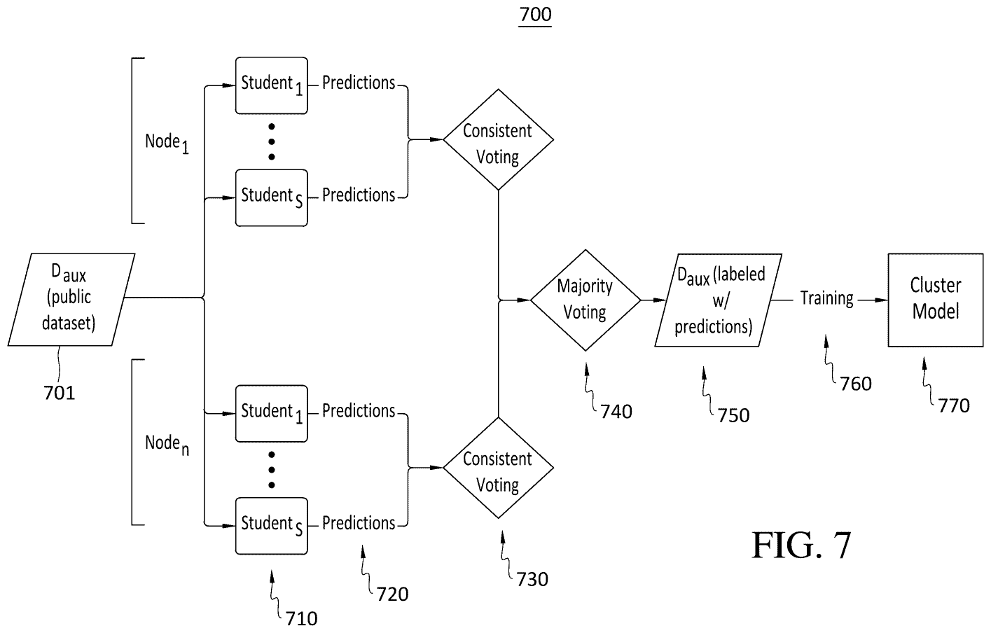

The aggregation algorithm used can be based on recursion of models making predictions, checking if they are consistent, and then performing a round of voting (e.g., majority voting) to label the dataset of the model that is being trained. This approach can be used within the training of cluster model 322, global model 332, and industry model 333. In many embodiments, training a cluster model 322 can be involve training students 312 within the nodes 310 of the cluster, as shown in FIG. 5 and further described below. Once all the students 312 in the cluster have been trained, trained student models 312 can be used by cluster hub 320 to learn a cluster model 322, as shown in FIG. 7 and further described below. Once trained, cluster model 322 can be made available to nodes 310 to use as node model 314. Further details about the training are described below. Once all the cluster models 322 have been trained, trained cluster models 322 can be used by global hub 330 to learn a global model 332 and/or industry models 333, as shown in FIG. 9 and further described below. Although system 300 is shown in FIG. 4 with four tiers (401-404), other systems can include another suitable number of tiers. For example, there can be another tier above the global tier, such as a universal tier that groups multiple global tiers. Accordingly, the global tier can group multiple clusters, but not be defined by global geography. Instead, the global tier can be cross domain, discipline, geographic boundary, etc.

Turning ahead in the drawings, FIG. 5 illustrates a flow chart for a method 500 of training students within a node, according to an embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, node 310 (FIGS. 3-4) can perform method 500 and/or one or more of the activities of method 500. For example, each node 310 (FIGS. 3-4) in a cluster and associated with a cluster hub (e.g., 320 (FIGS. 3-4) can perform method 500. In these or other embodiments, one or more of the activities of method 500 can be implemented as one or more computing instructions configured to run at one or more processors and configured to be stored at one or more non-transitory computer readable media. Such non-transitory computer readable media can be part of system 300 (FIG. 3), such as node 310 (FIG. 3). The processor(s) can be similar or identical to the processor(s) described above with respect to computer system 100 (FIG. 1).

Referring to FIG. 5, method 500 can begin with an activity 510 of a node (e.g., 310 (FIGS. 3-4)) creating students (e.g., student models 312 (FIGS. 3-4)) and teachers (e.g., teacher models 313 (FIGS. 3-4)). The number of students and teachers created for a node can be predetermined, administratively defined, customized by the user, or algorithmically determined at runtime, and, in many embodiments, can be consistent across the nodes of the cluster and/or consistent globally. As an example, there can be 20 nodes in a cluster, and each node can have 5 student, and each student in the node can have 3 teachers. Each of these models (e.g., teachers and students) can be a type of machine-learning model, such as XGBoost, random forest, neural network, GNN, GAN, a TFT model, an autoencoder-type model, an RL model, an HRL model, or another suitable type of machine-learning model, which can be consistent across the teachers and students of the node.

Next, method 500 can include an activity 520 of obtaining training data for training the teachers. The training data can be a labeled dataset, such as a local dataset 501 that is local to the node. In other embodiments, the dataset can be local or non-local (e.g., dataset shared across nodes, distributed data, sharded data, blockchain data, etc.), labeled or unlabeled, structured or unstructured. In some embodiments, local dataset 501 can be divided into subsets to create smaller datasets, such as datasets 1 to t, where t is the number of teachers for each student. These datasets can be used by the teachers to train the teachers. In embodiments in which unlabeled data is used, the unlabeled data can be correlated or clustered, such as by using a clustering algorithm (e.g., k-nearest neighbors, etc.), and the data can be labeled based on the clustering or correlation. This labeling can be performed algorithmically and/or by using human involvement.

Next, method 500 can include an activity 530 of training the teachers. Training the teachers with the labeled datasets obtained in activity 520 can be done according to conventional approaches to training the type of machine-learning model used by the teachers. Each teacher can be trained on its own dataset. In many embodiments, the node can train each of the teachers using training function 316 (FIG. 3). In many embodiments, the teachers for a student can be trained in sequence, asynchronously, or in parallel, and/or using parallel processing, distributed storage, distributed processing, etc. For example, process or storage resources can be used outside the node and/or the machine that hosts the node, such as if the node is out of resources or limited on resources, as part of a resource load balancing approach, etc.

Once the teachers for a student are trained, method 500 can include an activity 540 of generating predictions on an unlabeled student dataset. In several embodiments, the student dataset can be different for each node and each student. A datapoint from the student dataset can be provided to all of the teachers of the student (e.g., the same datapoint to each teacher). The machine-learning model for each trained teacher can provide a prediction for classifying that datapoint.

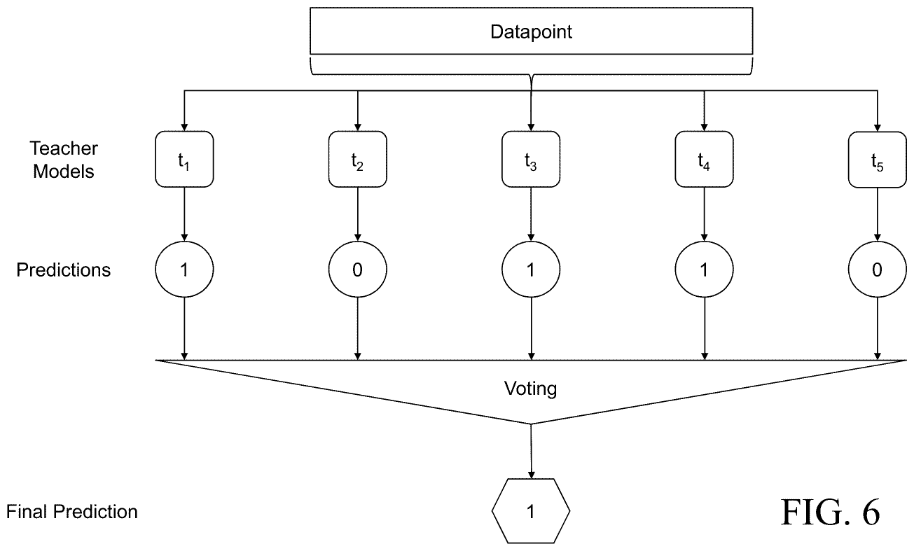

Once the predictions are obtained from the teachers, method 500 can include an activity 550 of voting. In some embodiments, majority voting can be used. In other embodiments, other types of voting can be used, such as unanimous voting, voting over a threshold number or percentage, or other suitable voting methods. FIG. 6 shows an example of majority voting for a student that has five teachers t₁-t₅ that receive a datapoint. Majority voting involves counting the number of votes per class, and the class with the most votes is the winner. In some embodiments, majority voting can be used at every tier within the federated system shown in FIG. 4. In the example shown in FIG. 6, three of the teachers predict 1 as the classification for the datapoint, and two of the teachers predict 0 as the classification for the datapoint. Using majority voting, class 1 receives 3 votes and class 0 receives 2 votes, so class 1 is selected as the final prediction. In many embodiments, the node can perform voting for each student using voting function 315 (FIG. 3).

Returning to FIG. 5, once the voting has been performed and a final prediction is obtained for that datapoint, method 500 can include an activity 560 of labeling the datapoint in the student dataset, Dₐᵤₓ. The final prediction can be set to the labeled classification value in the student dataset. Activities 540, 550, and 560 can be repeated for many or all the datapoints within the student dataset, to label the student dataset, so that it can be used to train the student.

Once the student dataset has been labeled, method 500 can include an activity 570 of training the student using the student dataset. In many embodiments, the node can train the student using training function 316 (FIG. 3). Each student can have its own dataset, which is labeled by its own teachers. Each student model in the node can trained with the respective dataset for respective student, creating multiple different trained student models within the node. If there are five student models, then the process of method 500 is performed five times, once for each student. In many embodiments, the students within a node can be trained in parallel, using parallel processing.

Once the student models have been trained, method 500 can include an activity 580 of outputting the student models. For example, the node can send the student models to the cluster hub (e.g., 320 (FIGS. 3-4)) for the node's cluster. In some embodiments, sending the student model to the cluster hub can involve sending the weights of the trained student model to the cluster hub. These student models for this node, as well as student models for other nodes of the cluster, can be used by the cluster hub to train the cluster model. The data used by the node for the teachers and/or the students is not shared with the cluster hub, thus maintaining privacy of this data.

In many embodiments, method 500 can be performed at each node in the cluster to create s number of trained student models for each node, and these trained student models associated with the nodes can be sent to the cluster hub.

Jumping ahead in the drawings, FIG. 7 illustrates a flow chart for a method 700 of aggregating student models from the nodes of the cluster to train a cluster model, according to an embodiment. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of method 700 can be performed in any suitable order. In still other embodiments, one or more of the procedures, the processes, and/or the activities of method 700 can be combined or skipped.

In many embodiments, cluster hub 320 (FIGS. 3-4) can perform method 700 and/or one or more of the activities of method 700. For example, each cluster hub 320 (FIGS. 3-4) can perform method 700. In these or other embodiments, one or more of the activities of method 700 can be implemented as one or more computing instructions configured to run at one or more processors and configured to be stored at one or more non-transitory computer readable media. Such non-transitory computer readable media can be part of system 300 (FIG. 3), such as cluster hub 320 (FIG. 3). The processor(s) can be similar or identical to the processor(s) described above with respect to computer system 100 (FIG. 1).

Referring to FIG. 7, method 700 can begin with an activity 710 of a cluster hub (e.g., 320 (FIG. 3)) obtaining the student models from the nodes in the cluster. For example, as nodes complete training their student models, the student models can be sent to the cluster hub, as described above in connection with activity 580 (FIG. 5). These student models for the nodes can be received at the cluster hub and stored, such as in a database (e.g., cluster database 326 (FIG. 3)). In some embodiments, these student models can be used as an ensemble at the cluster hub.

Next, method 700 can include an activity 720 of generating predictions on an unlabeled cluster training dataset, Dₐᵤₓ (701). A datapoint from the cluster training dataset can be provided to all of the student models from a node (e.g., the same datapoint to each student model for the node), and this same datapoint can be provided to all the student models from all the nodes in the cluster. The machine-learning model for each trained student model can provide a prediction for classifying that datapoint.

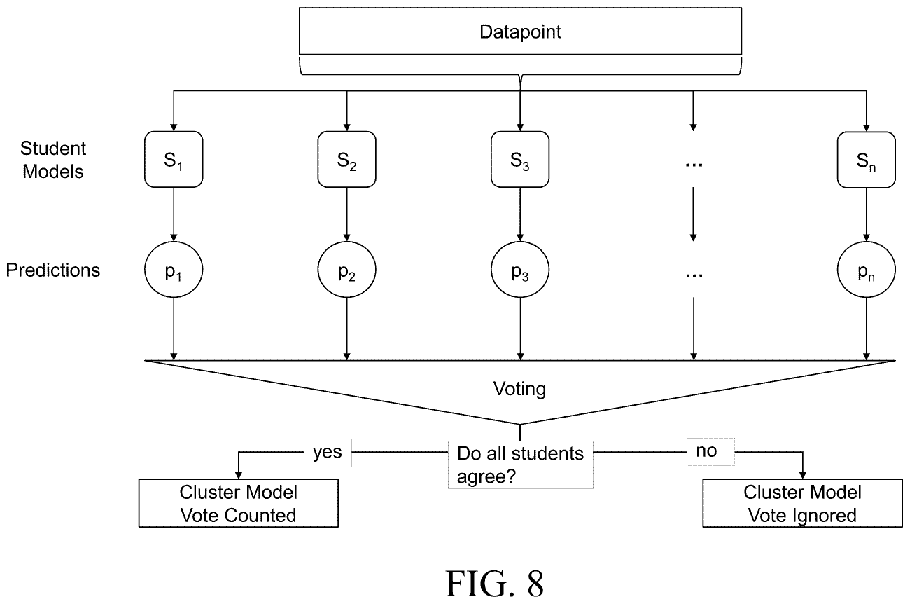

Once the predictions are obtained from the student models, method 700 can include voting, such as an activity 730 of consistency voting and an activity 740 of voting. Activities 730 and/or 740 can be performed by voting function 324 (FIG. 3). For activity 730, consistency voting can be performed for each node to decide if the group of student models from that node are classifying the training data to a sufficient degree. For example, a predetermined threshold can be used, such as 80%, 90%, or another suitable threshold. If the threshold is 90%, then the predictions from the student models of the node are compared to determine if at least 90% are consistent. If so, then all these predictions from the student models from the node are allowed to be used in the subsequent round of voting in activity 740. If not, then this node and its student models are excluded for this datapoint. FIG. 8 shows an example of consistency voting for the students models of a node. For student models Si to Sn, in which n is the number of students for the node, the predictions pi to pn were generated for a datapoint in activity 720. In the example shown in FIG. 8, the threshold is 100% (complete consistency), so if all the predictions from all the student models from that node agree, all of these predictions are used in subsequent voting in activity 740. Otherwise, these predictions are ignored in the subsequent voting in activity 740.

Activity 740 involves voting across the nodes, which can be majority voting, voting over a threshold number or percentage, or other suitable voting methods. Activity 740 can be similar to activity 550 (FIG. 5), and the majority voting shown in FIG. 6 can be used similarly for all the student models across all the nodes of the cluster that were not excluded in activity 730. In some embodiments, the tally for each classification across a node was stored in activity 730, and these tallies can be summed up across all the nodes to determine the classification to use for this datapoint, in accordance with the voting method used in activity 740, to determine the final prediction.

In some embodiments, activity 740 can include confidence filtering. Confidence filtering can involve determining if the number of votes for the class with the most votes (e.g., most students making that prediction) minus the number of votes for the class with the second-most votes (e.g., second-most students making that prediction) is at least a predetermined threshold. In other embodiments, confidence filtering can involve determining if the number of votes for the class with the most votes (e.g., most students making that prediction) minus the number of votes for the class with the least votes (e.g., least students making that prediction) is at least a predetermined threshold. For example, a confidence threshold, such as a confidence integer can be used, to ensure that there is sufficient in the class that won the majority voting. This confidence filtering can avoid 50/50 splits or other voting results that are close with insufficient margin of victory. If the confidence threshold is not met, that datapoint can be excluded from the training dataset of the cluster dataset model when the cluster model (e.g., 322 (FIG. 3)) is trained.

Continuing with FIG. 7, method 700 can include an activity 750 of labeling the datapoint in the cluster training dataset, Dₐᵤₓ. Unless excluded due to confidence filtering, the final prediction can be set to the labeled classification value in the cluster training dataset. Activities 720, 730, 740, and 750 can be repeated for many or all the datapoints within the cluster dataset, to label the cluster training dataset, so that it can be used to train the cluster model.

Once the cluster training dataset has been labeled, method 700 can include an activity 760 of training the cluster model using the cluster training dataset. In many embodiments, the cluster hub can train the cluster model using training function 325 (FIG. 3). Each cluster hub can have its own dataset, which is labeled by the student models of its nodes. The cluster model (e.g., 322 (FIG. 3)) can be a new model of the same type as the teachers and students (e.g., XGBoost, random forest, neural network, GNN, GAN, a TFT model, an autoencoder-type model, an RL model, an HRL model, or another suitable type of machine-learning model).

Once the cluster model has been trained, method 700 can include an activity 770 of outputting the trained cluster model. This trained cluster model can be stored in a database (e.g., cluster database 326 (FIG. 3)) in the cluster hub. The cluster hub can notify the nodes in the cluster that a new cluster model has been trained, and can send the trained cluster model to the nodes and/or allow the nodes to retrieve the trained cluster model from the cluster hub. Once the trained cluster model is obtained at a nodes, this trained cluster model can be used as the node model (e.g., 314 (FIGS. 3-4)) at the node for making inferences on incoming data. For example, a node can retrieve the weights of the trained cluster model and use those weights in the node model. In some embodiments, the new node model can replace an existing node model at the node. In a number of embodiments, multiple versions of models can be stored at a node, and the version to be used can be selected for use by the user or algorithmically. In several embodiments, lifecycle management of model versions can be handled at the nodes. In many embodiments, each node of the cluster can use the trained cluster model as the node model for making inferences on incoming data.

In many embodiments, inference function 317 (FIG. 3) can be used to perform inferencing at a node, which can involve using the node model (e.g., 314 (FIGS. 3-4)) on the incoming data to determine the classification. As the models at the nodes make inferences, if a flow (e.g., a sequence of incoming data at a node) is determined to be classification that is malicious, that data can be flagged as malicious, or put on hold of pulled for a human or an automated process to confirm or deny the classification. Once confirmed, the datapoint and the confirmed classification can be saved to the training dataset for the node to be used when retraining happens at the node. For example, the labeled datapoint can be added to a dataset used for retraining the node, and/or for training student(s) of the node. This datapoint is not shared outside the node, in order to preserve privacy of the data within the node.

In many embodiments, method 700 can be performed at each cluster across the global scope to create c number of trained cluster models, and these trained cluster models can be sent to the global hub for further aggregation globally and/or within industries. In many embodiments, cluster aggregator 323 (FIG. 3) can perform method 700. In some embodiments, aggregation at the cluster tier can be implemented as shown in the pseudocode in Algorithm 1 below:

Algorithm 1: Cluster Aggregation

```
if final model:
  for n in nodes:
    for s in students:
      for d in final_model_dataset:
        s.predict(d)
    for d in final_model_dataset:
      if students * CONSISTENCY_THRESHOLD agree on one type of
      classification:
        votes[classification] += length(students)
  for d in final_model_dataset:
    final_model_dataset[d][‘Label’] = max(votes[d])
  for v in votes:
    class_counts = sortRowDescendingOrder(row)
    if not class_counts[1] - class_counts[0] >
    CONFIDENCE_INTEGER:
      final_model_dataset drop row v
  return_final_model dataset
```

In many embodiments, method 700 and/or Algorithm 1 can be implemented in a way that is optimized and/or efficient. For example, in some embodiments, method 700 can be implemented with vectorization, hashing, and/or parallelization, and/or can run on CPUs and/or GPUs (graphical processing units).

Jumping ahead in the drawings, FIG. 9 illustrates a flow chart for a method 900 of aggregating cluster models from the cluster hubs to train a global model, according to an embodiment. Method 900 is merely exemplary and is not limited to the embodiments presented herein. Method 900 can be employed in many different embodiments or examples not specifically depicted or described herein. In some embodiments, the procedures, the processes, and/or the activities of method 900 can be performed in the order presented. In other embodiments, the procedures, the processes, and/or the activities of method 900 can be performed in any suitable order. In still other embodiments, one or more of the procedures, the processes, and/or the activities of method 900 can be combined or skipped.

In many embodiments, global hub 330 (FIGS. 3-4) can perform method 900 and/or one or more of the activities of method 900. In many embodiments, global aggregator 334 (FIG. 3) can perform method 900. In these or other embodiments, one or more of the activities of method 900 can be implemented as one or more computing instructions configured to run at one or more processors and configured to be stored at one or more non-transitory computer readable media. Such non-transitory computer readable media can be part of system 300 (FIG. 3), such as global hub 330 (FIG. 3). The processor(s) can be similar or identical to the processor(s) described above with respect to computer system 100 (FIG. 1).

Referring to FIG. 9, method 900 can begin with an activity 910 of a global hub (e.g., 330 (FIG. 3)) obtaining the cluster models from the cluster hubs. For example, as cluster hubs complete training their cluster models, the cluster models can be sent to the global hub, as described above in connection with activity 770 (FIG. 7). These cluster models for the cluster hubs can be received at the global hub and stored, such as in a database (e.g., global database 337 (FIG. 3)). In some embodiments, these cluster models can be used as an ensemble at the global hub.

Next, method 900 can include an activity 920 of generating predictions on an unlabeled global training dataset, Dₐᵤₓ (901). A datapoint from the global training dataset can be provided to all of the cluster models (e.g., the same datapoint to each cluster model). The machine-learning model for each trained cluster model can provide a prediction for classifying that datapoint.

Once the predictions are obtained from the cluster models, method 900 can include an activity 930 of voting. Activities 930 can be performed by voting function 335 (FIG. 3). The voting can be majority voting, voting over a threshold number or percentage, or other suitable voting methods. Activity 930 can be similar to activity 550 (FIG. 5) and/or activity 740 (FIG. 7), and the majority voting shown in FIG. 6 can be used similarly for all the cluster models received at the global hub. The final prediction can be determined in accordance with the voting method used in activity 930.

Continuing with FIG. 9, method 900 can include an activity 940 of labeling the datapoint in the global training dataset, Dₐᵤₓ. The final prediction determined in activity 930 can be set to the labeled classification value in the global training dataset. Activities 920, 930, and 940 can be repeated for many or all the datapoints within the global dataset, to label the global training dataset, so that it can be used to train the global model (e.g., 332 (FIG. 3)).

Once the global training dataset has been labeled, method 900 can include an activity 950 of training the global model using the global training dataset. In many embodiments, the global hub can train the global model using training function 336 (FIG. 3). The global model (e.g., 332 (FIG. 3)) can be a new model of the same type as the teachers, students, and cluster models (e.g., XGBoost, random forest, neural network, GNN, GAN, a TFT model, an autoencoder-type model, an RL model, an HRL model, or another suitable type of machine-learning model).

Once the global model has been trained, method 900 can include an activity 960 of outputting the trained global model. This trained global model can be stored in a database (e.g., global database 337 (FIG. 3)) in the global hub. The global hub can notify the nodes that a new global model has been trained, and can send the trained global model to the nodes and/or allow the nodes to retrieve the trained global model from the global hub. Once the trained global model is obtained at a nodes, this trained global model can be used as the node model (e.g., 314 (FIGS. 3-4)) at the node for making inferences on incoming data. For example, a node can retrieve the weights of the trained global model and use those weights in the node model. The new node model can replace an existing node model at the node. In many embodiments, each node can use the trained global model as the node model for making inferences on incoming data.

In many embodiments, method 900 can be used to train one or more industry models (e.g., 333 (FIG. 3)). An industry model (e.g., 333 (FIG. 3)) can be a model that gets the benefits of learnings from all the nodes, but is weighted to a specific industry. For example, there can be industries for mining, banking, military, etc. For example, the nodes (e.g., 310 (FIG. 3)) that are involved with the mining industry can be tagged as part of that industry. These industry groups can be defined by the user. If a sufficient number (e.g., at least a predetermined threshold) or percentage of nodes in a cluster are tagged in one industry, that cluster can be tagged as that industry. For example, if one cluster has a sufficient number of mining nodes (nodes tagged as mining industry), that cluster can be designated as being a mining industry cluster. Once the industry model has been trained, the nodes that are tagged for that industry can receive and/or pull the industry model.

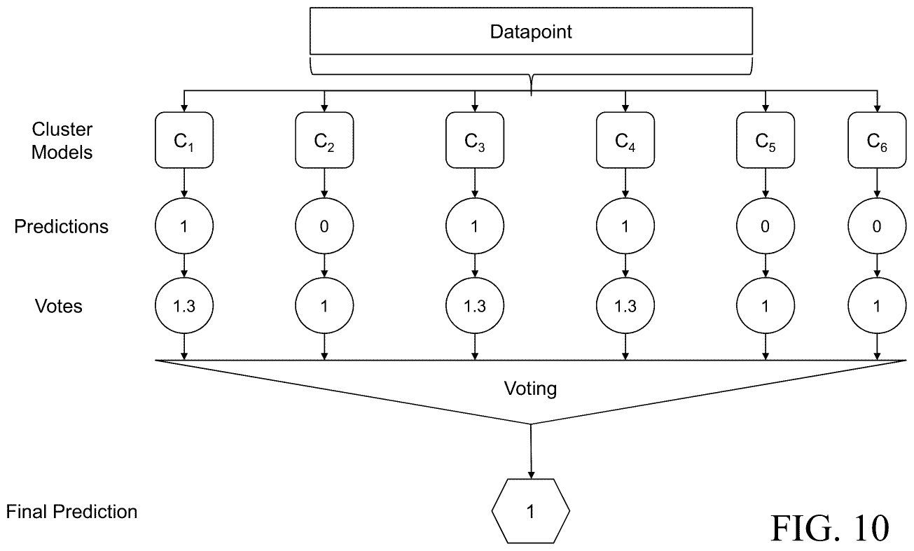

The industry model for a given industry can be trained in a similar manner as the global model, but in activity 930 of voting, a weighted voting can be used. In voting, cluster models tagged as in the industry can be given a weight that is greater than other cluster models. For example, the weight can be 30% more or another suitable weighting. FIG. 10 shows an example of weighted majority voting at a global hub across six cluster models C₁-C₆. Weighted majority voting involves counting the number of votes per class, and the class with the most votes is the winner, but assigning a higher number of votes to those cluster models tagged as in the industry. In the example shown in FIG. 10, cluster models C₁, C₃, and Ca are tagged as in the industry, so the votes from those cluster models are given a higher weight, in this case 1.3 instead of 1. Cluster models C₁, C₃, and C₄ predict 1 as the classification for the datapoint, and clusters C₂, C₅, and C₆ predict 0 as the classification for the datapoint. Using weighted majority voting, class 1 receives 3.9 votes, and class 0 receives 3 votes, so class 1 is selected as the final prediction. This final prediction is used as the label in the industry training dataset (similar to the global training dataset, but with different labels due to the weighted voting). In some embodiments, confidence filtering (e.g., activity 740 (FIG. 7)) can be used after the weighted voting for the industry models to determine if the datapoint will be included in the industry training dataset. The industry model (e.g., 333 (FIG. 3)) is then trained on the labeled industry training dataset, and can saved in a database (e.g., global database 337 (FIG. 3)) and/or be output and to the nodes that are tagged in that industry. This process of training an industry model (e.g., 333 (FIG. 3)) can be performed for each industry. In some embodiments, an industry model for one industry can be used for a different industry. For example, if an older industry behaves similarly to a new industry, but the new industry lacks initial training, the older model can be used for the new industry as a starting point.

In many embodiments, training a federation of federations can involve building multiple federated models (e.g., cluster models) from multiple clusters, and then using those models to build more federated models, such as global models and/or industry models, or models at other possible tiers. For example, if the model is an XGBoost model, the following steps can be performed:
1. For each node s Student and t Teacher models for each Student are initialized using model=Xgboost( ).
2. Teacher models start their training first, which trains their XGBoost models on their local data, model.train(x, y).
3. The trained teacher models then predict the values of every datapoint in their student's training dataset using model.predict(x).
4. Student models train on the data labeled by their teachers, model.train(x, y).
5. Student models then predict the values of every datapoint in their cluster model's training dataset using model.predict(x).
6. Cluster models train on the data labeled by their students, model.train(x, y).
7. Cluster models then predict the values of every datapoint in the global model's training dataset using model.predict(x).
8 Global model trains on the data labeled by their students, model.train(x, y).

Every time that a model finishes training, its weights get saved to a database (which can be a local on-premises database, a database service, a cloud-based database, a Saas (software as a service) database, a multi-tiered database, a high-availability database, etc.) to be queried by the necessary parties. Once the weights are queried, the models get reinitialized with the appropriate weights in order to make predictions.

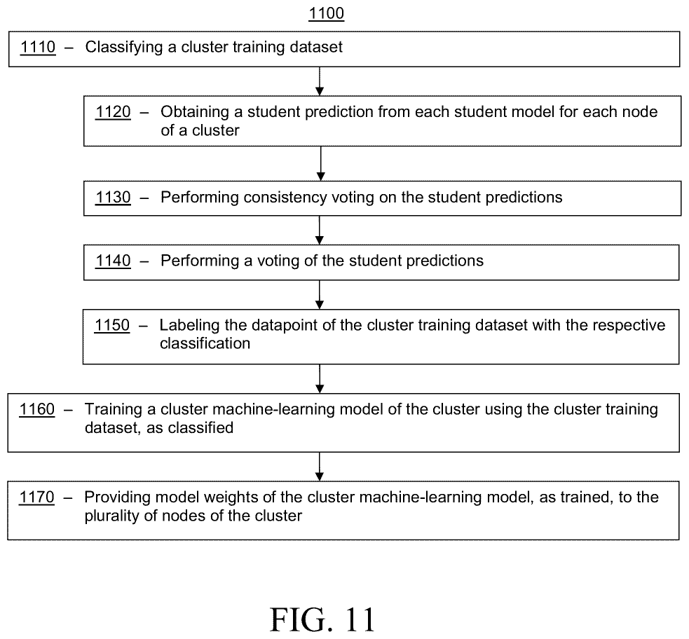

Turning ahead in the drawings, FIG. 11 illustrates a flow chart for a method 1100 of performing federated learning, according to an embodiment. Method 1100 is merely exemplary and is not limited to the embodiments presented herein. Method 1100 can be employed in many different embodiments or examples not specifically depicted or described herein. In some embodiments, the procedures, the processes, and/or the activities of method 1100 can be performed in the order presented. In other embodiments, the procedures, the processes, and/or the activities of method 1100 can be performed in any suitable order. In still other embodiments, one or more of the procedures, the processes, and/or the activities of method 1100 can be combined or skipped.

In many embodiments, system 300 (FIG. 3) or cluster hub 320 (FIG. 3) can be suitable to perform method 1100 and/or one or more of the activities of method 1100. In these or other embodiments, one or more of the activities of method 1100 can be implemented as one or more computing instructions configured to run at one or more processors and configured to be stored at one or more non-transitory computer readable media. Such non-transitory computer readable media can be part of system 300 (FIG. 3) or cluster hub 320 (FIG. 3). The processor(s) can be similar or identical to the processor(s) described above with respect to computer system 100 (FIG. 1).

Referring to FIG. 11, method 1100 can include an activity 1110 of classifying a cluster training dataset. In many embodiments, classifying a cluster training dataset can involve performing activities 1120, 1130, 1140, and/or 1150, described below, for each datapoint of the cluster training dataset. The cluster training dataset can be similar or identical to cluster training dataset 701 (FIG. 7). The grouping of nodes into a cluster (and/or the groupings of clusters at other levels, e.g., groupings of clusters at global, industry, etc.) can be defined algorithmically or manually, and can be predetermined or at runtime.

In several embodiments, activity 1110 can include an activity 1120 of obtaining a student prediction from each of a plurality of respective student machine-learning models for each a plurality of nodes of a cluster. In some embodiments, the cluster can be a group of nodes, such as a network of nodes. The nodes can be similar or identical to nodes 310 (FIGS. 3-4). The cluster can be associated with a cluster hub (e.g., 320 (FIGS. 3-4)). In some embodiments, a cluster can have multiple cluster hubs, a cluster hub can be associated with multiple clusters, or multiple cluster hubs can be associated with multiple clusters. The nodes can be a device, a server, a desktop, a NIC (e.g., network adapter 220 (FIG. 2)), a SmartNIC, a router, a switch, a firewall, a load balancer, another suitable network device, an operating system, an application, an IoT device, a processing container (e.g., a container running on a network device), a VM, a VDC, a virtual one of any of the foregoing elements that are a physical device (e.g., a virtual router, etc.) etc., or a component thereof. The student machine-learning models can be similar or identical to student models 312 (FIGS. 3-4) and/or the student models obtained in activity 710 (FIG. 7). In some embodiments, each of the plurality of respective student machine-learning models can be an XGBoost, random forest, neural network, GNN, GAN, a TFT model, an autoencoder-type model, an RL model, an HRL model, or another suitable type of model. The student predictions can be similar or identical to the predictions generated in activity 720 (FIG. 7).

In some embodiments, each of the plurality of respective student machine-learning models is trained based on teacher predictions provided by a plurality of respective teacher machine-learning models associated with each of the plurality of respective student machine-learning models. The teacher predictions can be similar or identical to the predictions generated in activity 540 (FIG. 5). The teacher machine-learning models can be similar or identical to teacher models 313 (FIG. 3). In some embodiments, a voting of the teacher predictions is used to label datapoints in a student training dataset. The voting can be similar or identical to activity 550 (FIG. 5) of voting. In some embodiments, each of the plurality of respective student machine-learning models is trained using the student training dataset, as labeled. The labeling can be similar or identical to activity 560 (FIG. 5). In some embodiments, each of the plurality of respective teacher machine-learning models is trained using a respective subset of a labeled training dataset before the plurality of respective teacher machine-learning models provide the teacher predictions. The subset of the labeled training dataset can be similar to the training data obtained in activity 520 (FIG. 5). The training of the teacher machine-learning models can be similar or identical to activity 530 (FIG. 5).

In a number of embodiments, activity 1110 also can include an activity 1130 of, before performing voting in activity 1140 (described below), for each node of the plurality of nodes of the cluster, performing consistency voting on the student predictions from the plurality of respective student machine-learning models of the node to determine if the node will participate in the voting. The consistency voting can be similar or identical to activity 730 (FIG. 7). In some embodiments, the consistency voting determines if the student predictions from the plurality of respective student machine-learning models satisfy a predetermined agreement threshold.

In several embodiments, activity 1110 additionally can include an activity 1140 of performing a voting of the student predictions from the plurality of respective student machine-learning models of at least a portion of the plurality of nodes of the cluster to determine a respective classification for the datapoint. In some embodiments, the voting comprises a majority voting. The voting can be similar or identical to activity 740 (FIG. 7). In some embodiments, performing the voting further comprises using confidence filtering with a predetermined confidence value.

In a number of embodiments, activity 1110 further can include an activity 1150 of labeling the datapoint of the cluster training dataset with the respective classification. The labeling can be similar or identical to activity 750 (FIG. 7).

In several embodiments, method 1100 also can include an activity 1160 of training a cluster machine-learning model of the cluster using the cluster training dataset, as classified. The cluster machine-learning model can be similar or identical to cluster model 322 (FIG. 3-4). In some embodiments, the cluster machine-learning model of the cluster and other cluster machine-learning models of other clusters provide cluster predictions to label a global training dataset. The cluster predictions can be similar or identical to the predictions generated in activity 920 (FIG. 9). The global training dataset can be similar or identical to global training dataset 901 (FIG. 9).

In some embodiments, the global training dataset is used to train a global machine-learning model. The global machine-learning model can be similar or identical to global model 332 (FIGS. 3-4). In some embodiments, model weights of the global machine-learning model, as trained, are provided to the plurality of nodes of the cluster and other nodes of the other clusters. For examples, these model weights are stored in a node model (e.g., 314 (FIG. 3)) within the node. In some embodiments, a voting of the cluster predictions is used to label datapoints in the global training dataset.

In some embodiments, the cluster machine-learning model of the cluster and other cluster machine-learning models of other clusters provide cluster predictions to label an industry-specific training dataset for an industry based on a weighted voting of the cluster predictions. The industry-specific training dataset can be similar to the global training dataset, but labeled with the classifications from weighted voting for the industry. In some embodiments, a subset of the cluster predictions are weighted heavier in the weighted voting when the subset of the cluster predictions are provided by clusters associated with the industry. In some embodiments, the industry-specific training dataset is used to train an industry-specific machine-learning model for the industry. The industry-specific machine-learning model can be similar or identical to industry model 333 (FIG. 3). In some embodiments, model weights of the industry-specific machine-learning model, as trained, are provided to nodes of the clusters associated with the industry. For examples, these model weights are stored in a node model (e.g., 314 (FIG. 3)) within the node associated with the industry.

In a number of embodiments, method 1100 additionally can include an activity 1170 of providing model weights of the cluster machine-learning model, as trained, to the plurality of nodes of the cluster. In some embodiments, each node of the plurality of nodes uses the model weights in a respective node machine-learning model to make inferences on incoming data received at the node. The node machine-learning model can be similar or identical to node model 314 (FIG. 3). In some embodiments, the respective node machine-learning model is used to make the inferences on the incoming data in an intrusion detection system or an intrusion prevention system at the node. In some embodiments, the respective node machine-learning model is used to make the inferences on the incoming data in a traffic routing function at the node.

The techniques described herein can provide a number of benefits over conventional approaches. A benefit of a federation of federations is that models can glean learnings from multiple different networks without communicating any private data. Federated learning conventionally involves a local tier (similar to tier 403 (FIG. 4)) and a central tier (similar to tier 402 (FIG. 4)). By contrast, the techniques described herein provide for further clustering of the central tier at a global tier, and/or using student-teacher tier in the local nodes, to provide up to four tiers (e.g., tiers 401-404 (FIG. 4)), and in some embodiments can involve more than four tiers. The techniques described herein can allow for networks within different industries to learn from data that they do not usually encounter. Doing so allows them to stay ahead of adversaries without having to incur an attack on their network.

The techniques described herein can advantageously be implemented in computer networking in routing and forwarding functions. Given a reinforcement learning model, a graph neural network (GNN), or another suitable type of machine-learning model, the models can vote on the best routes through the network, and based on that voting, the training datasets of the student, cluster models, and global model can be trained.

The voting algorithm is not just limited to binary classification, but it can also handle multiclass models and recommendation engines. Doing so allows the models to reside on the node on which they are deployed and remove the latency that is incurred when asking a central service where to send every packet.

Supervised learning is a subset of machine learning where the models receive feedback on their predictions, and they use that feedback to retrain and learn from what they did right or wrong. Supervised learning can be used at the node tier (e.g., tier 403 (FIG. 4). Once the nodes receive either a cluster model, global model, or industry model, which is stored in the node as the node model (e.g., 314 (FIGS. 3-4)), they will use that model to perform inference on the data that comes in at their location. As an example, for the use case of intrusion detection, when a malicious flow is detected, it can be sent to a user interface for a human to verify whether or not it is actually malicious. If it is deemed to be benign or malicious, then the data associated with that flow (e.g., sequence of packets received) and the final classification can be stored in a local database in the node to be used when the node goes through retraining in order to learn more about the data that it encounters. The benefit of doing this allows for quicker learning and for cross-cluster model-learning of current attacks, in an effort to stay ahead of adversaries. In some embodiments, some or all of the envelope, some or all of the metadata, and/or some or all of the payload of packets can be considered in a flow as features for inference by the model. Various patterns of attacks can be learned. In a routing use case, the payload data is not typically considered, except in some cases to consider the type of traffic (e.g., voice traffic). This approach can be used in other applications, such as application identification, classification, generative configurations, and other suitable applications.

Additionally, there is the potential for a malicious attack to occur on a node or cluster model that alters the behavior of the model, and this risk can be taken into consideration when designing a federated system. While conventional approaches choose to run a separate algorithm to notice big changes, the techniques described herein can use a different approach. The following components of the algorithm can maintain the robustness of the models:
1 Confidence Filtering: can provide a certain level of agreeance, if one model is not agreeing with the rest, its opinion will not be taken into account.
2. Majority Voting: can provide that if all votes are leaning towards one type of classification and one models' vote is different, then the classification with the most votes will be used.
3. Deployment Logic: can provide that, before a cluster, global, or industry model is deployed to the nodes, there is a check if the accuracy and false positive rate have decreased. If they have decreased, then that model will not be deployed. For example, a common benchmark dataset can be used across the models. The benchmark dataset can include known attached, such as a man in the middle attack, and if the model performs worse

In many embodiments, the techniques described herein can preserve privacy in deep learning approaches. By storing the cluster, global, and/or industry models at the local nodes, the techniques described herein can reduce latency by making models local to the nodes, reduce bandwidth for calls to remote resources (e.g., the cloud or otherwise outside the node), and reduce storage in remote resources (e.g., the cloud or otherwise outside the node). In some embodiments, these techniques can handle more data than conventional machine learning approaches, and can handle heterogeneous systems.

The techniques described herein can advantageously allow for single-round convergence. The voting techniques described herein allow for a single round of training, as opposed to the many rounds used in conventional federated learning approaches. Many conventional federated learning approaches use unsupervised machine learning, but the techniques described herein also can use supervised machine learning.

The techniques described herein can use a different method of aggregation that conventional approaches in federated learning. Conventional approaches include (1) FedSGD, which utilizes stochastic gradient descent at the node level and then sends the gradients of those models to the hub where the gradients are averaged proportionally to the number of training samples on each node, and used to make a gradient descent step for the hub's model; (2) FedAVG, which uses federated averaging, in which all models to be aggregated train and send up their weights and then those weights are averaged together, with multiple rounds, which does not work well for tree-based methods; and (3) FedAgg (Federated aggregation), which minimizes the loss function for each client, applies stochastic gradient descent for each local model every round, then averages all client weights.

By contrast, the techniques described herein can use voting, which labels the data set on which a new model will train. Voting allows for single-round convergence for the global and cluster models. Voting also can employ confidence voting and filtering, which can make the model more robust. Voting can allow aggregating on the decisions of the models, which can allow for easier retraining and general training than averaging weights or gradients. Voting also can allow this algorithm to be used for many different types of machine-learning models, not just neural nets or trees. In some conventional approaches, nodes are sampled (randomly selected) for training to limit the work involved in convergence, but using voting allows for single-round convergence, so all of the nodes can be more easily handled, which can create stronger models with better training.

The techniques described herein can provide benefits over conventional approaches by building a global model as well as industry-specific models, in which the industry-specific models utilize learning from other industries as well, with different weightings.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMS, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although federated learning has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-11 may be modified, and that the foregoing discussion of certain of these embodiments does not necessarily represent a complete description of all possible embodiments. For example, one or more of the procedures, processes, or activities of FIGS. 5, 7, 9, and 11 may include different procedures, processes, and/or activities and be performed by many different modules, in many different orders, and/or one or more of the procedures, processes, or activities of FIGS. 5, 7, 9, and 11 may include one or more of the procedures, processes, or activities of another different one of FIGS. 5, 7, 9, and 11. As another example, the elements within system 300 (FIGS. 3-4), nodes 310 (FIGS. 3-4, cluster hubs 320 (FIGS. 3-4), and/or global hub 330 (FIGS. 3-4) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method comprising:
classifying a cluster training dataset by, for each datapoint of the cluster training dataset:
obtaining a student prediction from each of a plurality of respective student machine-learning models for each a plurality of nodes of a cluster;
performing a voting of the student predictions from the plurality of respective student machine-learning models of at least a portion of the plurality of nodes of the cluster to determine a respective classification for the datapoint; and
labeling the datapoint of the cluster training dataset with the respective classification; and
training a cluster machine-learning model of the cluster using the cluster training dataset, as classified.

2. The method of claim 1 further comprising:
providing model weights of the cluster machine-learning model, as trained, to the plurality of nodes of the cluster.

3. The method of claim 2, wherein each node of the plurality of nodes uses the model weights in a respective node machine-learning model to make inferences on incoming network data received at the node.

4. The method of claim 3, wherein the respective node machine-learning model is used to make the inferences on the incoming network data in an intrusion detection system or an intrusion prevention system at the node.

5. The method of claim 3, wherein the respective node machine-learning model is used to make the inferences on the incoming network data in a traffic routing function at the node.

6. The method of claim 2, wherein each node of the plurality of nodes uses the model weights in a respective node machine-learning model that identifies items of interest in a security imagery feed received at the node.

7. The method of claim 2, wherein each node of the plurality of nodes uses the model weights in a respective node machine-learning model that performs natural language processing at the node for spam detection.

8. The method of claim 2, wherein each node of the plurality of nodes uses the model weights in a respective node machine-learning model that detects anomalies from one or more baselines at the node.

9. The method of claim 1, wherein performing the voting further comprises using confidence filtering with a predetermined confidence value.

10. The method of claim 1 further comprising, before performing the voting, for each node of the plurality of nodes of the cluster:
performing consistency voting on the student predictions from the plurality of respective student machine-learning models of the node to determine if the node will participate in the voting.

11. The method of claim 10, wherein the consistency voting determines if the student predictions from the plurality of respective student machine-learning models satisfy a predetermined agreement threshold.

12. The method of claim 1, wherein each of the plurality of respective student machine-learning models is trained based on teacher predictions provided by a plurality of respective teacher machine-learning models associated with each of the plurality of respective student machine-learning models.

13. The method of claim 12, wherein a voting of the teacher predictions is used to label datapoints in a student training dataset.

14. The method of claim 13, wherein each of the plurality of respective student machine-learning models is trained using the student training dataset, as labeled.

15. The method of claim 12, wherein each of the plurality of respective teacher machine-learning models is trained using a respective subset of a labeled training dataset before the plurality of respective teacher machine-learning models provide the teacher predictions.

16. The method of claim 1, wherein the cluster machine-learning model of the cluster and other cluster machine-learning models of other clusters provide cluster predictions to label a global training dataset.

17. The method of claim 16, wherein:
the global training dataset is used to train a global machine-learning model; and
model weights of the global machine-learning model, as trained, are provided to the plurality of nodes of the cluster and other nodes of the other clusters.

18. The method of claim 16, wherein a voting of the cluster predictions is used to label datapoints in the global training dataset.

19. The method of claim 1, wherein:
the cluster machine-learning model of the cluster and other cluster machine-learning models of other clusters provide cluster predictions to label an industry-specific training dataset for an industry based on a weighted voting of the cluster predictions; and
a subset of the cluster predictions are weighted heavier in the weighted voting when the subset of the cluster predictions are provided by clusters associated with the industry.

20. The method of claim 19, wherein:
the industry-specific training dataset is used to train an industry-specific machine-learning model for the industry; and
model weights of the industry-specific machine-learning model, as trained, are provided to nodes of the clusters associated with the industry.

21. The method of claim 1, wherein each of the plurality of respective student machine-learning models comprises one of an XGBoost model, a random forest model, a neural network model, a GNN model, a GAN model, a TFT model, an autoencoder-type model, an RL model, or an HRL model.

22. The method of claim 1, wherein at least one of the plurality of nodes comprises a SmartNIC.

23. The method of claim 1, wherein at least one of the plurality of nodes comprises a router.

24. The method of claim 1, wherein at least one of the plurality of nodes comprises a switch.

25. The method of claim 1, wherein at least one of the plurality of nodes comprises a firewall.

26. The method of claim 1, wherein at least one of the plurality of nodes comprises a load balancer.

27. The method of claim 1, wherein at least one of the plurality of nodes comprises an IoT device.

28. The method of claim 1, wherein at least one of the plurality of nodes comprises a processing container running on a network device.

29. The method of claim 1, wherein at least one of the plurality of nodes comprises a virtual machine.

30. The method of claim 1, wherein at least one of the plurality of nodes comprises a virtual device context.

31. The method of claim 1, wherein at least one of the plurality of nodes comprises an operating system.

32. The method of claim 1, wherein at least one of the plurality of nodes comprises an application.

33. The method of claim 1, wherein the voting comprises a majority voting.

34. A system comprising:
one or more processors; and
one or more non-transitory computer-readable media storing computing instructions that, when executed on the one or more processors, cause the one or more processors to perform:
classifying a cluster training dataset by, for each datapoint of the cluster training dataset:
obtaining a student prediction from each of a plurality of respective student machine-learning models for each a plurality of nodes of a cluster;
performing a voting of the student predictions from the plurality of respective student machine-learning models of at least a portion of the plurality of nodes of the cluster to determine a respective classification for the datapoint; and
labeling the datapoint of the cluster training dataset with the respective classification; and
training a cluster machine-learning model of the cluster using the cluster training dataset, as classified.

35. The system of claim 34, wherein the computing instructions, when executed on the one or more processors, further cause the one or more processors to perform:
providing model weights of the cluster machine-learning model, as trained, to the plurality of nodes of the cluster.

36. The system of claim 35, wherein each node of the plurality of nodes uses the model weights in a respective node machine-learning model to make inferences on incoming network data received at the node.

37. The system of claim 36, wherein the respective node machine-learning model is used to make the inferences on the incoming network data in an intrusion detection system or an intrusion prevention system at the node.

38. The system of claim 36, wherein the respective node machine-learning model is used to make the inferences on the incoming network data in a traffic routing function at the node.

39. The system of claim 35, wherein each node of the plurality of nodes uses the model weights in a respective node machine-learning model that identifies items of interest in a security imagery feed received at the node.

40. The system of claim 35, wherein each node of the plurality of nodes uses the model weights in a respective node machine-learning model that performs natural language processing at the node for spam detection.

41. The system of claim 35, wherein each node of the plurality of nodes uses the model weights in a respective node machine-learning model that detects anomalies from one or more baselines at the node.

42. The system of claim 34, wherein performing the voting further comprises using confidence filtering with a predetermined confidence value.

43. The system of claim 34, wherein the computing instructions, when executed on the one or more processors, further cause the one or more processors to perform, before performing the voting, for each node of the plurality of nodes of the cluster:
performing consistency voting on the student predictions from the plurality of respective student machine-learning models of the node to determine if the node will participate in the voting.

44. The system of claim 43, wherein the consistency voting determines if the student predictions from the plurality of respective student machine-learning models satisfy a predetermined agreement threshold.

45. The system of claim 34, wherein each of the plurality of respective student machine-learning models is trained based on teacher predictions provided by a plurality of respective teacher machine-learning models associated with each of the plurality of respective student machine-learning models.

46. The system of claim 45, wherein a voting of the teacher predictions is used to label datapoints in a student training dataset.

47. The system of claim 46, wherein each of the plurality of respective student machine-learning models is trained using the student training dataset, as labeled.

48. The system of claim 45, wherein each of the plurality of respective teacher machine-learning models is trained using a respective subset of a labeled training dataset before the plurality of respective teacher machine-learning models provide the teacher predictions.

49. The system of claim 34, wherein the cluster machine-learning model of the cluster and other cluster machine-learning models of other clusters provide cluster predictions to label a global training dataset.

50. The system of claim 49, wherein:
the global training dataset is used to train a global machine-learning model; and
model weights of the global machine-learning model, as trained, are provided to the plurality of nodes of the cluster and other nodes of the other clusters.

51. The system of claim 49, wherein a voting of the cluster predictions is used to label datapoints in the global training dataset.

52. The system of claim 34, wherein:
the cluster machine-learning model of the cluster and other cluster machine-learning models of other clusters provide cluster predictions to label an industry-specific training dataset for an industry based on a weighted voting of the cluster predictions; and
a subset of the cluster predictions are weighted heavier in the weighted voting when the subset of the cluster predictions are provided by clusters associated with the industry.

53. The system of claim 52, wherein:
the industry-specific training dataset is used to train an industry-specific machine-learning model for the industry; and
model weights of the industry-specific machine-learning model, as trained, are provided to nodes of the clusters associated with the industry.

54. The system of claim 34, wherein each of the plurality of respective student machine-learning models comprises one of an XGBoost model, a random forest model, a neural network model, a GNN model, a GAN model, a TFT model, an autoencoder-type model, an RL model, or an HRL model.

55. The system of claim 34, wherein at least one of the plurality of nodes comprises a SmartNIC.

56. The system of claim 34, wherein at least one of the plurality of nodes comprises a router.

57. The system of claim 34, wherein at least one of the plurality of nodes comprises a switch.

58. The system of claim 34, wherein at least one of the plurality of nodes comprises a firewall.

59. The system of claim 34, wherein at least one of the plurality of nodes comprises a load balancer.

60. The system of claim 34, wherein at least one of the plurality of nodes comprises an IoT device.

61. The system of claim 34, wherein at least one of the plurality of nodes comprises a processing container running on a network device.

62. The system of claim 34, wherein at least one of the plurality of nodes comprises a virtual machine.

63. The system of claim 34, wherein at least one of the plurality of nodes comprises a virtual device context.

64. The system of claim 34, wherein at least one of the plurality of nodes comprises an operating system.

65. The system of claim 34, wherein at least one of the plurality of nodes comprises an application.

66. The system of claim 34, wherein the voting comprises a majority voting.
